(19) United States
(12) Patent Application Publication
(10) Pub. No.: US 2005/0024897 A1
(43) Pub. Date: Feb. 3, 2005

(54) Synchronized rectifying controller for a forward power converter

(76) Inventors: Ta-Yung Yang, Milpitas, CA (US); Jenn-Yu G. Lin, Taipei (TW); Chern-Lin Chen, Taipei (TW)

Correspondence Address: J.C. Patents, Inc., Suite 250, 4 Venture, Irvine, CA, 92618, US

(21) Appl. No.: 10/629,150

(22) Filed: Jul. 28, 2003

(51) Int. Cl. H02M 3/335

(52) U.S. Cl. 363/21.06

(57) ABSTRACT

The present invention provides a forward power converter with a synchronized rectifying controller. The synchronized rectifying controller has a detection input for detecting the voltage of a secondary winding of a transformer, and thereby accurately measuring the PWM signal. Based on this measurement, the synchronized rectifying controller generates control signals for two secondary-side rectifying MOSFETs. The present invention also introduces a delay time using a timing resistor coupled to the synchronized rectifying controller. This avoids cross-conduction from secondary-side MOSFETs. The present invention also includes an output current-sense mechanism to avoid reverse inductor currents under light-load conditions.

### BACKGROUND OF THE INVENTION

1. Field of the Invention

The present invention relates to a pulse-width-modulation (PWM) forward power converter. More particularly, the present invention relates to a forward power converter employing a secondary controller to synchronously drive a pair of output rectifiers.

2. Description of the Related Art

Power converters are widely used by various electronic products to convert an AC input voltage into a DC supply voltage.

Various topologies such as flyback, forward, half-bridge, and full-bridge have been developed for different power needs. In traditional power converters, diodes are usually used as secondary rectifying components. In applications where high output currents frequently occur, the high forward voltage drop across the diodes causes significant power loss, which reduces power conversion efficiency. To avoid this problem, some power supplies use MOSFETs having low on-state resistance, instead of diodes. This substitution can reduce power consumption and improve power conversion efficiency.

Some synchronized rectifying controllers sense the primary gate signal to avoid cross-conduction from the secondary-side MOSFETs. This technique can reduce propagation delay, but it requires using an opto-coupler or an additional transformer to maintain isolation between the primary-side and the secondary-side of the main transformer. This increases the cost and complexity of the circuit. Another drawback of this approach is that the circulated conduction losses increase under light-load condition. Such reversed inductor currents increase component stress and reduce power conversion efficiency.

Therefore, there is a need for a synchronized rectifying controller with a precise output voltage detection circuit.

### SUMMARY OF THE INVENTION

A primary object of the present invention is to provide a forward power converter with a synchronized rectifying controller to control the rectifying MOSFETs of the forward power converter.

It is another object of the present invention to prevent cross-conduction between the rectifying MOSFETs.

It is a further object of the present invention to prevent reverse inductor currents. This reduces component stress and improves power conversion efficiency under light-load conditions. The forward power converter according to the present invention includes a current-sense mechanism to avoid reverse currents from the output inductor.

It is another object of the present invention to monitor the voltage from the secondary winding of the transformer. This reduces the cost and complexity of the detection circuit.

According to an aspect of the present invention, the synchronized rectifying controller according to the present invention can control two rectifying MOSFETs so that the forward power converter can provide a clean output voltage. The forward power converter according to the present invention prevents cross-conduction of the rectifying MOSFETs by controlling the maximum on-time of a second rectifying MOSFET, in a manner that is programmable and precise. The synchronized rectifying controller according to the present invention determines the maximum on-time using a timing resistor coupled to a single-pulse generator.

It is to be understood that both the foregoing general descriptions and the following detailed descriptions are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 shows a schematic diagram of a prior-art forward power converter using diodes as rectifying components.

FIG. 2A shows the circuit operation of a prior-art forward power converter while a primary-side MOSFET is turned on.

FIG. 2B shows the circuit operation of a prior-art forward power converter while the primary-side MOSFET is turned off.

FIG. 3 shows a schematic diagram of a prior-art forward power converter using MOSFETs as rectifying components.

FIG. 4 shows a schematic diagram of a forward power converter including a synchronized rectifying controller according to the present invention.

FIG. 5 shows a forward power converter including the synchronized rectifying controller according to a preferred embodiment of the present invention.

FIG. 6 shows the synchronized rectifying controller according to a preferred embodiment of the present invention.

FIG. 7 shows a single-pulse generator of the synchronized rectifying controller according to a preferred embodiment of the present invention.

FIG. 8 shows the timing diagram of the synchronized rectifying controller according to the present invention.

### DESCRIPTION OF THE PREFERRED EMBODIMENTS

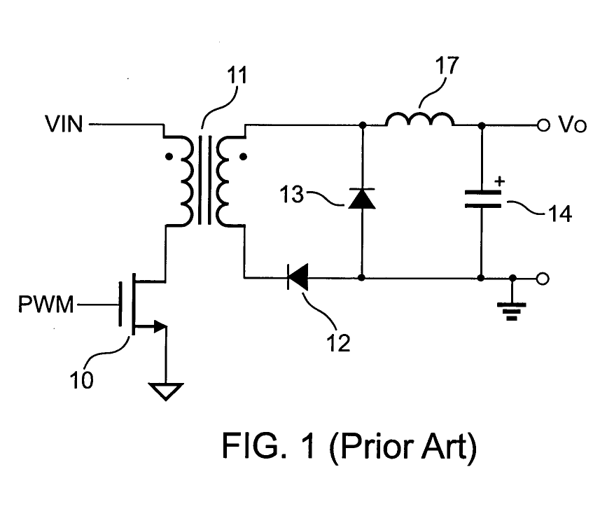

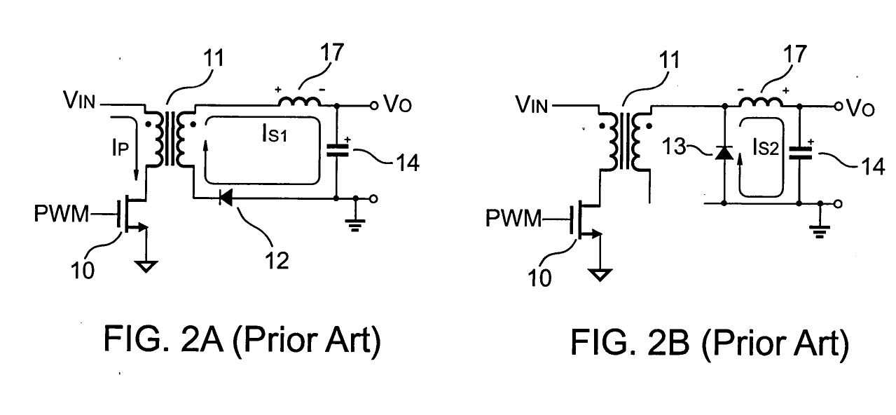

FIG. 1 shows a typical forward power converter. When a primary-side MOSFET 10 is turned on by a logic-high PWM signal, energy is transferred from the primary-side to the secondary-side of a transformer 11. As FIG. 2A shows, the voltage across a secondary winding of the transformer 11 will start to charge an output inductor 17 and an output capacitor 14 via a rectifying diode 12. Once the PWM signal drops to logic-low, as shown in FIG. 2B, the primary-side MOSFET 10 will be turned off and the output inductor 17 will begin to release its energy to the output capacitor 14 via a rectifying diode 13. However, the on-state voltage drop across the secondary-side rectifying diodes 12 and 13 causes significant power consumption, which reduces power conversion efficiency. In order to solve this problem, the secondary-side rectifying diodes can be replaced with MOSFETs. The parasitic diodes of the MOSFETs have low on-state voltage drops, so this technique can improve power conversion efficiency.

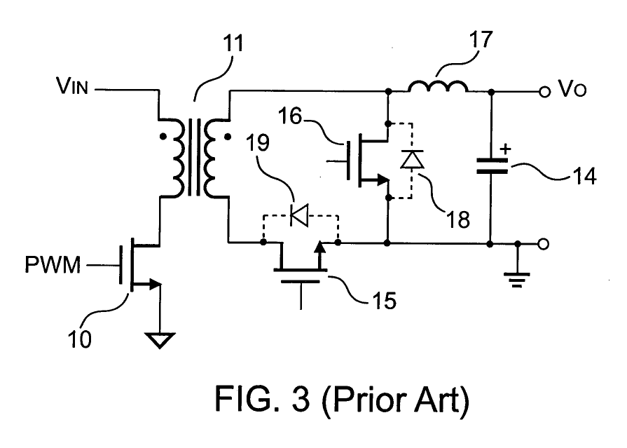

As FIG. 3 shows, a parasitic diode 19 of a MOSFET 15 and a parasitic diode 18 of a MOSFET 16 replace the rectifying diode 12 and the rectifying diode 13 shown in FIG. 1. By properly synchronizing the gate signals of the MOSFETs 15 and 16, the forward converter can produce the same output power while reducing power loss. To precisely synchronize the gate signals of the MOSFETs 15 and 16, it is necessary to accurately measure the PWM signal.

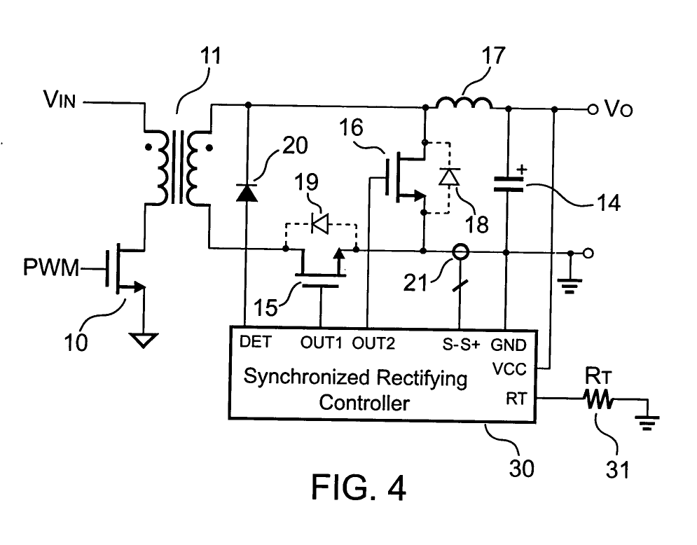

FIG. 4 shows a schematic circuit diagram of a forward power converter having a synchronized rectifying controller 30 according to the present invention. Referring to FIG. 4, the forward power converter comprises a transformer 11 having a primary winding connected to a primary circuit and a secondary winding connected to a secondary circuit. A primary-side MOSFET 10 is coupled to the primary winding of the transformer 11 to control power conduction. A detection diode 20 is connected between a positive end of the secondary winding of the transformer 11 and a detection input DET of the synchronized rectifying controller 30. An output inductor 17 is connected from the positive end of the secondary winding of the transformer 11 and a positive end of the power converter output. An output capacitor 14 is connected across the positive end of the power converter output and the ground reference. A gate of a MOSFET 15 is driven by a first output OUT1 of the synchronized rectifying controller 30. A gate of a MOSFET 16 is driven by a second output OUT2 of the synchronized rectifying controller 30. A drain of the MOSFET 15 is connected to a negative end of the secondary winding of the transformer 11. A source of the MOSFET 15 is connected to a source of the MOSFET 16. A drain of the MOSFET 16 is connected to the positive end of the secondary winding of the transformer 11. The source of the MOSFET 16 is connected to the ground reference via a current-sense mechanism 21.

The synchronized rectifying controller 30 has the detection input DET for detecting the PWM signal from the voltage of the secondary winding. Once a logic-high signal is detected at the detection input DET via the detection diode 20, the synchronized rectifying controller 30 will turn on the MOSFET 15 and the energy from the secondary winding will charge the output inductor 17 and the output capacitor 14 via the parasitic diode 19 of the MOSFET 15 during the conduction period. When the conduction period stops, the MOSFET 16 will be turned on and the energy stored in the output inductor 17 will be freewheeled into the output capacitor 14 via the parasitic diode 18 of the MOSFET 16.

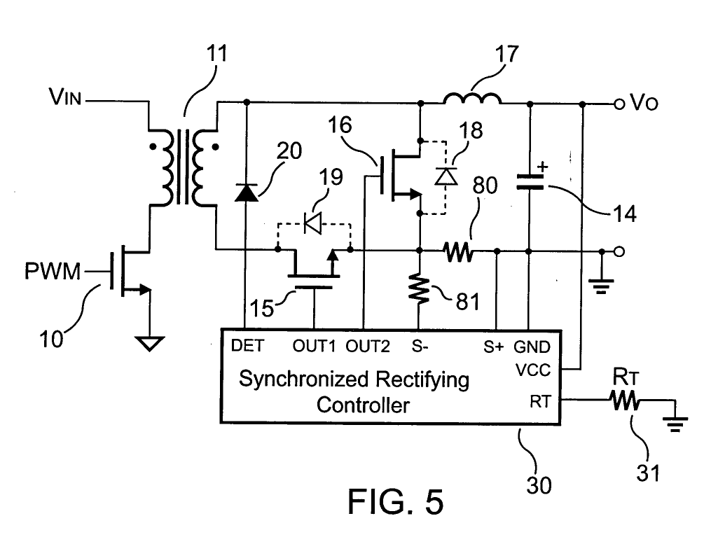

FIG. 5 shows the forward power converter according to one preferred embodiment the present invention. The current-sense mechanism 21 shown in FIG. 4 is composed of a first resistor 80 and a second resistor 81. The first resistor 80 is connected between the source of the MOSFET 16 and a positive-sense input S+ of the synchronized rectifying controller 30. The second resistor 81 is connected between the source of the MOSFET 16 and a negative-sense input S− of the synchronized rectifying controller 30. The positive-sense input S+ is connected to the ground reference of the power converter and a ground pin GND of the synchronized rectifying controller 30. A supply-voltage pin VCC of the synchronized rectifying controller 30 is connected to the positive end of the power converter output. A timing resistor 31 is connected between an input RT of the synchronized rectifying controller 30 and the ground reference.

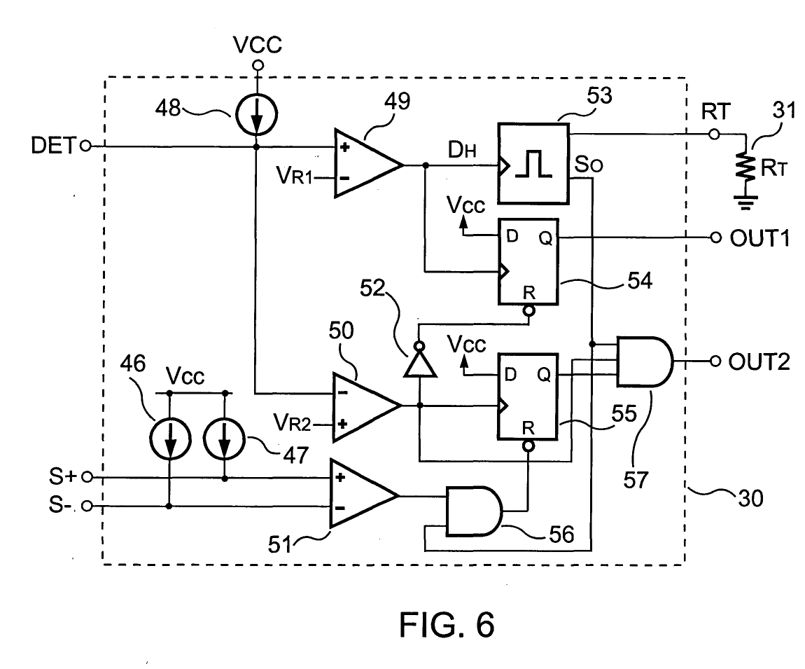

FIG. 6 shows the synchronized rectifying controller 30 according to a preferred embodiment of the present invention. The synchronized rectifying controller 30 comprises comparators 49, 50 and 51, current sources 46, 47 and 48, a NOT-gate 52, an AND-gate 56, an AND-gate 57, two flip-flops 54 and 55 and a single-pulse generator 53. A positive input of the comparator 49 and a negative input of the comparator 50 are coupled to the detection input DET of the synchronized rectifying controller 30. The current source 48 is connected between the supply voltage pin VCC and the positive input of the comparator 49. A reference voltage V_{R1} supplies a negative input of the comparator 49. A reference voltage V_{R2} supplies a positive input of the comparator 50. The current source 46 is connected from the supply voltage pin VCC to a negative input of the comparator 51. The current source 47 is connected from the supply voltage pin VCC to a positive input of the comparator 51. The positive input and the negative input of the comparator 51 are respectively the positive-sense input S+ and the negative-sense input S− of the synchronized rectifying controller 30. An output of the comparator 49 is connected to a first input D_{H} of the single-pulse generator 53 and a CLOCK-input of the flip-flop 54. A second input of the single-pulse generator 53 is coupled to the timing resistor 31. An output S_{O} of the single-pulse generator 53 is connected to a first input of the AND-gate 56 and a first input of the AND-gate 57. An output of the comparator 50 is connected to a second input of the AND-gate 57, an input of the NOT-gate 52, and a CLOCK-input of the flip-flop 55. An output of the flip-flop 55 is connected to a third input of the AND-gate 57. An output of the comparator 51 is connected to a second input of the AND-gate 56. The flip-flop 54 is reset by an output of the NOT-gate 52. The flip-flop 55 is reset by an output of the AND-gate 56. An input of the flip-flop 54 and an input of the flip-flop 55 are connected to the supply voltage pin VCC. The output of the flip-flop 54, which is also the first output OUT1 of the synchronized rectifying controller 30, generates a first gate-signal to control the MOSFET 15 shown in FIG. 5. The output of the AND-gate 57, which is also the second output OUT2 of the synchronized rectifying controller 30, generates a second gate-signal to control the MOSFET 16 shown in FIG. 5.

The transformer 11 is a forward transformer. When the PWM signal is logic-high, the primary-side MOSFET 10 will be turned on and the input voltage V_{IN} will be conducted through the primary winding of the transformer 11. The primary winding and the secondary winding will accumulate energy proportionally from the input voltage V_{IN}. The voltage of the positive terminal of the secondary winding will begin to rise. Eventually, it will exceed the voltage of the reference voltage V_{R1}, causing the comparator 49 to output a logic-high signal. This logic-high signal generated by the comparator 49 will trigger the flip-flop 54. The flip-flop 54 will then output a logic-high first gate-signal to the first output OUT1 of the synchronized rectifying controller 30.

When the PWM signal goes off, the voltage of the positive terminal of the secondary winding will drop to zero. The comparator 50 will output a logic-high signal to the input of the NOT-gate 52. The NOT-gate 52 will invert this logic-high signal and reset the flip-flop 54 to clear the first gate-signal at the first output OUT1 of the synchronized rectifying controller 30.

When a high voltage occurs at the positive terminal of the secondary winding, the single-pulse generator 53 will be activated by the output of the comparator 49. This will cause the single-pulse generator 53 to output a pulse-signal S_{O}. The resistance of the timing resistor 31 determines a period T₁ of the pulse-signal S_{O}. When the voltage at the positive terminal of the secondary winding drops below a level of a reference voltage V_{R2}, the flip-flop 55 will be triggered by the output of the comparator 50. The flip-flop 55 will output a logic-high signal to the third input of the AND-gate 57. When the output of the comparator 50, the output of the flip-flop 55, and the pulse-signal S_{O} are all logic-high, the AND-gate 57 will generate a logic-high second gate-signal to the second output OUT2 of the synchronized rectifying controller 30.

Following the period T₁, the pulse-signal S_{O} will drop to logic-low and disable the AND-gate 57. The output of the AND-gate 57 will be cleared to terminate the on-period of the second gate-signal. The period T₁ introduces a delay time T_{d} before the start of the next switching signal. Without the delay time T_{d}, a short-circuit condition could occur during the next switching period if the MOSFET 16 is still turned on. According to the present invention, the period T₁ of the single-pulse generator 53 can be adjusted to determine the precisely turn-off time of the MOSFET 16, ensuring that the MOSFET 16 turns off before next switching period starts.

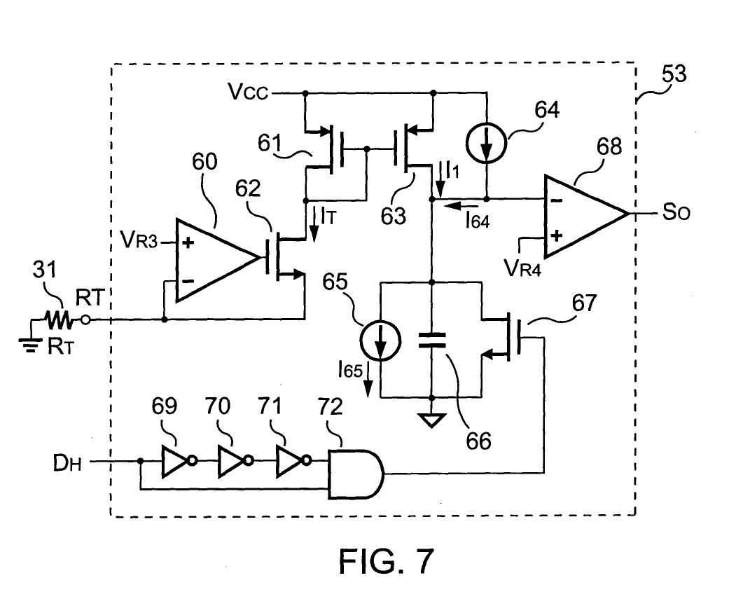

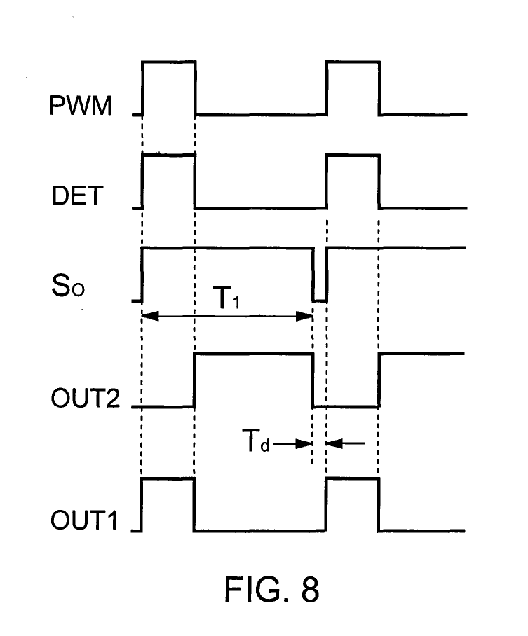

FIG. 7 shows the single-pulse generator 53 according to a preferred embodiment of the present invention. The single-pulse generator 53 comprises an operational amplifier (OPA) 60, NOT-gates 69, 70 and 71, an AND-gate 72, a MOSFET 62, a current mirror composed of three MOSFETs 61 and 63, current sources 64 and 65, a capacitor 66, a MOSFET 67 and an OPA 68. A reference voltage V_{R3} is supplied to a positive input of the OPA 60. A negative input of the OPA 60 is coupled to a source of the MOSFET 62 and the timing resistor 31. An output of the OPA 60 is connected to a gate of the MOSFET 62. A drain of the MOSFET 61, a drain of the MOSFET 62, a gate of the MOSFET 61, and a gate of the MOSFET 63 are tied together. A source of the MOSFET 61 and a source of the MOSFET 63 are connected to the supply voltage pin VCC. A drain of the MOSFET 63 is connected to a negative input of the OPA 68 and a drain of the MOSFET 67. The current source 64 is connected between the supply voltage pin VCC and the negative input of the OPA 68. A reference voltage V_{R4} is supplied to a positive input of the OPA 68. The capacitor 66 and the current source 65 are connected in parallel between the drain and a source of the MOSFET 67. The source of the MOSFET 67 is connected to the ground reference. A gate of the MOSFET 67 is connected to an output of the AND-gate 72. The NOT-gates 69, 70 and 71 are connected in series. An output of the NOT-gate 69 is connected to an input of the NOT-gate 70. An output of the NOT-gate 70 is connected to an input of the NOT-gate 71. An output of the NOT-gate 71 is connected to a first input of the AND-gate 72. A second input of the AND-gate 72 and an input of the NOT-gate 69 are connected to the output of the comparator 49 shown in FIG. 6. An output of the comparator 68 is the output of the single-pulse generator 53, which supplies the pulse-signal S_{O}.

When the voltage at the positive terminal of the secondary winding is low, the comparator 49 will output a logic-low signal to the first input D_{H} of the single-pulse generator 53. This logic-low signal will disable the AND-gate 72. The MOSFET 67 will remain off due to the logic-low signal output from the AND-gate 72. The comparator 60, the MOSFET 62, and the timing resistor 31 will generate a current I_{T}. The current mirror mirrors the current I_{T} to a first current I₁ which is coupled with the current source 64 to charge the capacitor 66. The amplitude of the current I_{T} is given by following equation, where R_{T} is the resistance of the timing resistor 31:
I_{T}=V_{R3}/R_{T} (1)

The first current I₁ can be expressed by the following equation, where N₆₃/N₆₁ is the geometric ratio of the MOSFETs 63 and 61:
I₁=(N₆₃/N₆₁)×I_{T} (2)

Before the voltage across the capacitor 66 exceeds the voltage of the reference voltage V_{R4}, which provides a threshold voltage for generating the pulse-signal S_{O}, the output of the single-pulse generator 53 will remain logic-high. The period T₁ of the single-pulse generator 53 is determined by the charge time of the capacitor 66, which can be expressed by the following equation, where C₆₆ is the capacitance of the capacitor 66, I₆₄ is the current of the current source 64, and I₆₅ is the current of the current source 65:

$${T}_{1} = \frac{{C}_{66} \times {V}_{R4}}{{I}_{64} + {I}_{1} - {I}_{65}} \qquad ( 3 )$$

The current sources 64 and 65 are programmable. Increasing the current I₆₄ and decreasing the current I₆₅ can shorten the delay time T_{d}. Decreasing the current I₆₄ and increasing the current I₆₅ can expand the delay time T_{d}. This allows the delay time T_{d} to be optimized to compensate for variations to the switching frequency. Such variations can be caused by factors such as temperature, component degradation, etc. The delay time T_{d} before the start of each switching cycle can be expressed by the following equation, where T is the period of the PWM signal:
T_{d}=T−T₁ (4)

Once the voltage detected from the positive terminal of the secondary winding exceeds the voltage of the reference voltage V_{R1}, the voltage at the first input D_{H} of the single-pulse generator 53 will become logic-high. This logic-high signal will be supplied to the second input of the AND-gate 72. However, the NOT-gates 69,70 and 71 will delay the signal from the first input D_{H} of the single-pulse generator 53.

Before the logic-high signal from the first input D_{H} of the single-pulse generator 53 can propagate through to the first input of the AND-gate 72, the output of the AND-gate 72 will be logic-high for an instant. This will turn on the MOSFET 67 to discharge the capacitor 66. When the delayed signal from the first input D_{H} of the single-pulse generator 53 finally propagates through to the first input of the AND-gate 72, the MOSFET 67 will be turned off. Then the capacitor 66 will begin to be charged.

Further referring to FIG. 5 and FIG. 6, the resistors 80 and 81 are used to prevent the flow of an inverse discharge current from the output capacitor 14 to the MOSFET 16. When the capacitor 14 begins to supply an inverse discharge current, it will cause the voltage at the negative-sense input S− to exceed the voltage at the positive-sense input S+. The comparator 51 will output a logic-low signal to disable the output of the AND-gate 56. This will reset the flip-flop 55 and turn off the second gate-signal at the second output OUT2 of the synchronized rectifying controller 30.

It will be apparent to those skilled in the art that various modifications and variations can be made to the structure of the present invention without departing from the scope or spirit of the present invention. In view of the foregoing, it is intended that the present invention cover modifications and variations of this invention provided that they fall within the scope of the following claims and their equivalents.

1. A forward power converter, comprising:
an input voltage source;
a transformer having a primary winding and a secondary winding;
a primary circuit coupled to said primary winding;
a first MOSFET having a drain connected to a negative terminal of said secondary winding, wherein said first MOSFET has a source connected to a first terminal of a first resistor;
a second MOSFET having a drain connected to a positive terminal of said secondary winding, wherein said second MOSFET has a source connected to said source of said first MOSFET and a first terminal of a second resistor; and
a controller for generating a first output-control signal and a second output-control signal to synchronously control said first MOSFET and said second MOSFET.

2. The forward power converter as claimed in claim 1 further comprising:
an output inductor connected between said positive terminal of said secondary winding and an output terminal of the power converter;
an output capacitor having a positive terminal connected to said output terminal of the power converter and a negative terminal connected to the ground reference;
a detection diode coupled between said positive terminal of said secondary winding and a detection input of said controller; and
a programmable timing resistor.

3. The forward power converter as claimed in claim 1, wherein said primary circuit comprises:
a switching device for conducting a current from said input voltage source to said primary winding, wherein said primary winding conducts a current from said input voltage source to said primary winding only when said switching device is on; and
a switching signal generator for operating said switching device.

4. The forward power converter as claimed in claim 1, wherein said controller comprises:
a first comparator having a positive input connected to an anode of said detection diode, wherein said first comparator has a negative input connected to a first reference voltage terminal;
a second comparator having a negative input connected to said anode of said detection diode, wherein said second comparator has a positive input connected to a second reference voltage terminal;
a third comparator having a positive input connected to a second terminal of said first resistor, wherein said third comparator has a negative input connected to a second terminal of said second resistor;
a first current source connected between a supply voltage terminal and said positive input of said first comparator;
a second current source connected between the supply voltage terminal and said negative input of said third comparator; and
a third current source connected between the supply voltage terminal and said positive input of said third comparator.

5. The forward power converter as claimed in claim 1, wherein said controller further comprises:
a single-pulse generator for generating a single-pulse signal, wherein said single-pulse generator has a first input connected to an output of said first comparator, wherein said single-pulse generator has a second input coupled to said programmable timing resistor;
a first flip-flop for providing said first output-control signal, wherein said first flip-flop has a first input connected to the supply voltage terminal, wherein said first flip-flop has a second input connected to the output of said first comparator;
a second flip-flop having a first input connected to the supply voltage terminal, said second flip-flop having a second input connected to an output of said second comparator;
a first NOT-gate for supplying a reset signal to a RESET-input of said first flip-flop, wherein said first NOT-gate has an input connected to said output of said second comparator;
a first AND-gate having a first input connected to an output of said single-pulse generator, wherein said first AND-gate has a second input connected to an output of said third comparator, wherein said first AND-gate has an output connected to a RESET-input of said second flip-flop; and
a second AND-gate for providing said second output-control signal, wherein said second AND-gate has a first input connected to said output of said single-pulse generator, wherein said second AND-gate has a second input connected to said output of said second comparator, wherein said second AND-gate has a third input connected to an output of said second flip-flop.

6. The forward power converter as claimed in claim 5, wherein said single-pulse generator comprises:
an operational amplifier having a positive input connected to a third reference voltage terminal, wherein said operational amplifier has a negative input connected to said programmable timing resistor;
a third MOSFET having a gate connected to an output of said operational amplifier, wherein said third MOSFET has a source connected to said programmable timing resistor;
a current mirror,
a fourth current source connected in parallel with said current mirror; and
a fourth comparator having a negative input coupled to said fourth current source, wherein said fourth comparator has a positive input connected to a fourth reference voltage terminal.

7. The forward power converter as claimed in claim 5, wherein said single-pulse generator further comprises:
a delay circuit, wherein said delay circuit includes at least three NOT-gates connected in series to create a delay time, wherein an input of said delay circuit is coupled to said output of said first comparator;
a third AND-gate having a first input connected to an output of said delay circuit, wherein said third AND-gate has a second input connected to said input of said delay circuit;
a fourth MOSFET having a gate connected to an output of said third AND-gate, wherein said fourth MOSFET has a drain coupled to said negative input of said fourth comparator, wherein said fourth MOSFET has a source connected to the ground reference;
a fifth current source connected between said negative input of said fourth comparator and the ground reference; and
a capacitor coupled in parallel with said fifth current source.
